(19) United States
(12) Patent Application Publication
(10) Pub. No.: US 2024/0127327 A1
(43) Pub. Date: Apr. 18, 2024

(54) METHOD OF LEASING POWER STORAGE, COMPUTER APPARATUS, AND LEASE SYSTEM

(71) Applicant: TOYOTA JIDOSHA KABUSHIKI KAISHA, Toyota-shi (JP)

(72) Inventors: Yuko TERASAWA, Tokyo-to (JP); Makoto KAKUCHI, Toyota-shi (JP); Toshiaki KARASAWA, Tokyo-to (JP); Takeshi HIGASHI, Nagoya-shi (JP); Yoshihiko ENDO, Tokyo-to (JP)

(73) Assignee: TOYOTA JIDOSHA KABUSHIKI KAISHA, Toyota-shi (JP)

(21) Appl. No.: 18/481,640

(22) Filed: Oct. 5, 2023

(30) Foreign Application Priority Data
Oct. 13, 2022 (JP) 2022-164735

(51) Int. Cl. G06Q 30/0645; G06Q 40/08; G06Q 50/06

(52) U.S. Cl. CPC G06Q 30/0645; G06Q 40/08; G06Q 50/06

(57) ABSTRACT

A method of leasing a power storage includes obtaining, for a vehicle including a power storage, a value of the power storage based on a capacity retention rate of the power storage, determining an insurance fee for a user of the vehicle to receive an insurance service relating to replacement of the power storage based on an accident risk of the vehicle, and determining a lease fee of the power storage based on the value of the power storage and the insurance fee.

### CROSS REFERENCE TO RELATED APPLICATIONS

This nonprovisional application is based on Japanese Patent Application No. 2022-164735 filed with the Japan Patent Office on Oct. 13, 2022, the entire contents of which are hereby incorporated by reference.

### BACKGROUND

### Field

The present disclosure relates to a method of leasing a power storage, a computer apparatus, and a lease system.

### Description of the Background Art

Japanese Patent Laying-Open No. 2020-177652 discloses determining a rental fee (that is, a battery lease fee) paid by a user for rental of a battery mounted on a vehicle, in accordance with a full charge capacity of the battery.

### SUMMARY

The inventors of the present application newly propose a lease service not only simply for rental of a power storage for a vehicle but also for rental of a power storage with a value being added. Though a method described in Japanese Patent Laying-Open No. 2020-177652 may be able to properly assess a value of the power storage itself based on the full charge capacity of the power storage, it is difficult to properly assess the value added to the lease service. Therefore, it is difficult to properly determine a lease fee of the power storage in the new service with the previously-described method described in Japanese Patent Laying-Open No. 2020-177652.

The present disclosure was made to solve the problem above, and an object thereof is to properly determine a lease fee of a power storage in a lease service not only simply for rental of a power storage for a vehicle but also for rental of a power storage with a value being added.

According to a form according to a first point of view of the present disclosure, a method of leasing a power storage shown below is provided.

(Clause 1) The method of leasing a power storage includes obtaining, for a vehicle including a power storage, a value of the power storage based on a capacity retention rate of the power storage, determining an insurance fee for a user of the vehicle to receive an insurance service relating to replacement of the power storage based on an accident risk of the vehicle, and determining a lease fee of the power storage based on the value of the power storage and the insurance fee.

In the leasing method, the insurance service is added as an added value to the lease service for rental of the power storage for the vehicle. The insurance service relating to replacement of the power storage is a service to exempt at least a part of compensation liability of a user (more specifically, compensation liability of a user for an owner of the power storage) who has caused deterioration or failure of the power storage. The owner of the power storage is, for example, a leasing company. For example, when a user who purchased the insurance satisfies a prescribed replacement requirement, the user may be provided with a substitute power storage at no charge (or only with a prescribed commission fee). The user may detach the power storage that has deteriorated or failed, for example, at a station where the power storage mounted on the vehicle is to be replaced and attach a new power storage (a less deteriorated power storage) provided by the station to the vehicle.

In the leasing method, the value of the power storage is found based on the capacity retention rate of the power storage. As the capacity retention rate of the power storage is higher, the value of the power storage tends to be higher. Therefore, obtaining of the value of the power storage based on the capacity retention rate thereof facilitates proper assessment of the value of the power storage. Furthermore, in the leasing method, not only the fee paid by the user for the power storage (that is, the fee in accordance with the value of the power storage) but also the insurance fee paid by the user for reception of the insurance service is included in the lease fee of the power storage. In the leasing method, the insurance fee is determined based on an accident risk of the vehicle. The accident risk represents possibility that the vehicle is involved in an accident in the future. In the event that the vehicle is involved in an accident, possibility of requirement for replacement of the power storage mounted on that vehicle is high. Therefore, determination of the insurance fee based on the accident risk facilitates proper assessment of the insurance fee. Thus, according to the leasing method described above, in the lease service not only simply for rental of the power storage for the vehicle but also for rental of the power storage with the value being added, the lease fee of the power storage can properly be determined.

The method of leasing a power storage described in Clause 1 may be configured according to any one of Clauses 2 to 5 shown below.

(Clause 2) The method according to Clause 1 further includes a feature below. The determining an insurance fee includes assessing the accident risk based on travel data of the vehicle during an assessment period preceding a coverage period of the insurance service and determining the insurance fee for the coverage period based on the accident risk assessed in connection with the assessment period. The travel data includes at least one of a cumulative travel distance or a cumulative time period of travel of the vehicle and a distance or a time period of travel of the vehicle in a congested environment.

In the leasing method, the accident risk is assessed based on the travel data of the vehicle during the assessment period preceding the coverage period of the insurance service, and the insurance fee for the coverage period of the insurance service is determined based on the assessed accident risk. In addition, the travel data used for assessment of the accident risk includes the distance or the time period of travel. Therefore, according to the method, proper assessment of the accident risk is facilitated and appropriate determination of the insurance fee is facilitated.

(Clause 3) The method according to Clause 1 or 2 further includes a feature below. The determining an insurance fee includes first insurance fee determination processing for determining the insurance fee based on the accident risk of the vehicle and a deterioration risk of the power storage and second insurance fee determination processing for determining the insurance fee based only on the accident risk, of the accident risk and the deterioration risk. The leasing method further includes determining the insurance fee in the first insurance fee determination processing when a body portion except for the power storage of the vehicle is a property of the user and the power storage is provided to the user by lease. The leasing method further includes determining the insurance fee in the second insurance fee determination processing when both of the body portion and the power storage are provided to the user by lease.

A vehicle, a body portion (a portion except for the power storage) of which is a property of the user and a power storage of which is provided to the user by lease, is referred to as a “partial lease vehicle” below. A vehicle, both of the body portion and the power storage of which are provided to the user by lease, is referred to as a “full lease vehicle.” According to the method, appropriate determination of the insurance fee for each of the partial lease vehicle and the full lease vehicle is facilitated.

(Clause 4) The method according to Clause 3 further includes a feature below. The determining the insurance fee in the first insurance fee determination processing includes assessing the accident risk as being higher as a distance or a time period of travel of the vehicle is longer during an assessment period preceding a coverage period of the insurance service, assessing the deterioration risk as being higher as a time period during which a remaining amount of stored power of the power storage is equal to or larger than a prescribed value is longer during the assessment period, and determining the insurance fee for the coverage period based on the accident risk and the deterioration risk assessed in connection with the assessment period.

In the leasing method, as the distance or the time period of travel of the vehicle is longer during the assessment period, the accident risk is assessed as being higher. Proper assessment of the accident risk is thus facilitated. As the time period during which the remaining amount of stored power of the power storage is equal to or larger than the prescribed value is longer during the assessment period, the deterioration risk is assessed as being higher. When a power storage is left in a state where the remaining amount of stored power is large, deterioration of the power storage tends to be accelerated. Therefore, according to the method, proper assessment of the deterioration risk is facilitated. Proper assessment of the accident risk and the deterioration risk facilitates appropriate determination of the insurance fee.

(Clause 5) The method according to Clause 3 or 4 further includes a feature below. The determining the insurance fee in the first insurance fee determination processing further includes assessing the deterioration risk as being higher as the distance or the time period of travel of the vehicle in a cold area is longer during the assessment period.

When a vehicle travels in the cold area, deterioration of the power storage tends to be accelerated. Therefore, according to the method, proper assessment of the deterioration risk is facilitated.

According to one form, a program that causes a computer to perform the method of leasing a power storage according to any one of Clauses 1 to 5 is provided. In another form, a computer apparatus that distributes the program is provided.

According to a form according to a second point of view of the present disclosure, a computer apparatus shown below is provided.

(Clause 6) The computer apparatus includes a processor and a storage where a program causing the processor to perform the method of leasing a power storage according to any one of Clauses 1 to 5 is stored.

According to the computer apparatus, the method described previously is suitably performed.

According to a form according to a third point of view of the present disclosure, a lease system for lease of a power storage shown below is provided.

(Clause 7) The lease system for lease of a power storage incudes the computer apparatus according to Clause 6 and a user terminal of the vehicle. The computer apparatus is configured to notify the user terminal of the vehicle of the determined lease fee. The user terminal is configured to show the lease fee.

According to the lease system, the user terminal of the vehicle is notified of the lease fee determined in the method described previously and the lease fee is shown on the user terminal. The user of the vehicle can thus know the lease fee.

The user terminal may be a vehicle-mounted terminal mounted on the vehicle or a portable terminal carried by the user of the vehicle. The user terminal may be registered in the computer apparatus in advance in association with the vehicle. (Clause 8) The lease system according to Clause 7 further includes a feature below. The computer apparatus is configured to notify the user terminal of the vehicle of measures for lowering the lease fee, together with an amount of lowering in lease fee owing to the measures. The user terminal is configured to show the measures for lowering the lease fee, together with ranking of the amount of lowering in lease fee owing to the measures.

According to the lease system, the user of the vehicle can know the measures for lowering the lease fee. In addition, the user can know the ranking of the amount of lowering in lease fee (that is, magnitude of an effect of the measures). Therefore, the user can compare and weigh up the lease fee and convenience with each other, and then can select measures to be taken from presented measures.

(Clause 9) The lease system according to Clause 7 or 8 further includes a feature below. The computer apparatus gives to the user terminal of the vehicle, a notification that encourages replacement of the power storage under the insurance service when the capacity retention rate of the power storage becomes equal to or less than a prescribed threshold value.

According to the lease system, when the capacity retention rate of the power storage mounted on the vehicle lowers, the notification is given to the user terminal. Therefore, the user who receives the notification can replace the power storage under the insurance service. According to the lease system, the user can replace the power storage each time the capacity retention rate of the power storage lowers, and use of the vehicle over a long period can be facilitated.

(Clause 10) The lease system according to any one of Clauses 7 to 9 further includes a feature below. When the capacity retention rate of the power storage becomes equal to or less than the prescribed threshold value, the computer apparatus restricts control of the power storage by the vehicle to protect the power storage, and when replacement of the power storage is completed in the vehicle, the computer apparatus removes restriction on the control.

According to the lease system, during a period from lowering in capacity retention rate of the power storage until completion of replacement of the power storage, control of the power storage can be restricted to protect the power storage. Excessive deterioration of the power storage can thus be suppressed. Therefore, reuse of the power storage detached from the vehicle by replacement is facilitated.

The vehicle including the power storage may be an electrically powered vehicle (xEV) that uses electric power as the entirety or a part of a motive power source. Examples of the xEV include a battery electric vehicle (BEV), a hybrid electric vehicle (HEV), a plug-in hybrid electric vehicle (PHEV), and a fuel cell electric vehicle (FCEV).

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a diagram for illustrating overview of a lease system for lease of a power storage according to an embodiment of the present disclosure.

FIG. 2 is a diagram for illustrating a configuration and an operation of a battery station included in the lease system according to the embodiment of the present disclosure.

FIG. 3 is a flowchart showing processing involved with battery replacement in a method of leasing a power storage according to the embodiment of the present disclosure.

FIG. 4 is a diagram for illustrating information managed by a management center included in the lease system according to the embodiment of the present disclosure.

FIG. 5 is a flowchart showing processing performed by a dealer terminal at the time of registration of a new vehicle in the leasing method according to the embodiment of the present disclosure.

FIG. 6 is a flowchart showing processing involved with determination of a lease fee at the time of renewal of a lease contract in the leasing method according to the embodiment of the present disclosure.

FIG. 7 is a diagram for illustrating a method of determining an insurance fee and a lease fee in the leasing method according to the embodiment of the present disclosure.

FIG. 8 is a diagram for illustrating a configuration of a vehicle including a rental power storage in the lease system according to the embodiment of the present disclosure.

FIG. 9 is a flowchart showing control for suppression of rise of the lease fee in the leasing method according to the embodiment of the present disclosure.

FIG. 10 is a diagram for illustrating notification processing shown in FIG. 9.

FIG. 11 is a flowchart showing notification control carried out by a partial lease vehicle in the leasing method according to the embodiment of the present disclosure.

FIG. 12 is a diagram for illustrating exemplary notification in processing shown in FIG. 11.

### DESCRIPTION OF THE PREFERRED EMBODIMENTS

An embodiment of the present disclosure will be described in detail with reference to the drawings. The same or corresponding elements in the drawings have the same reference characters allotted and description thereof will not be repeated.

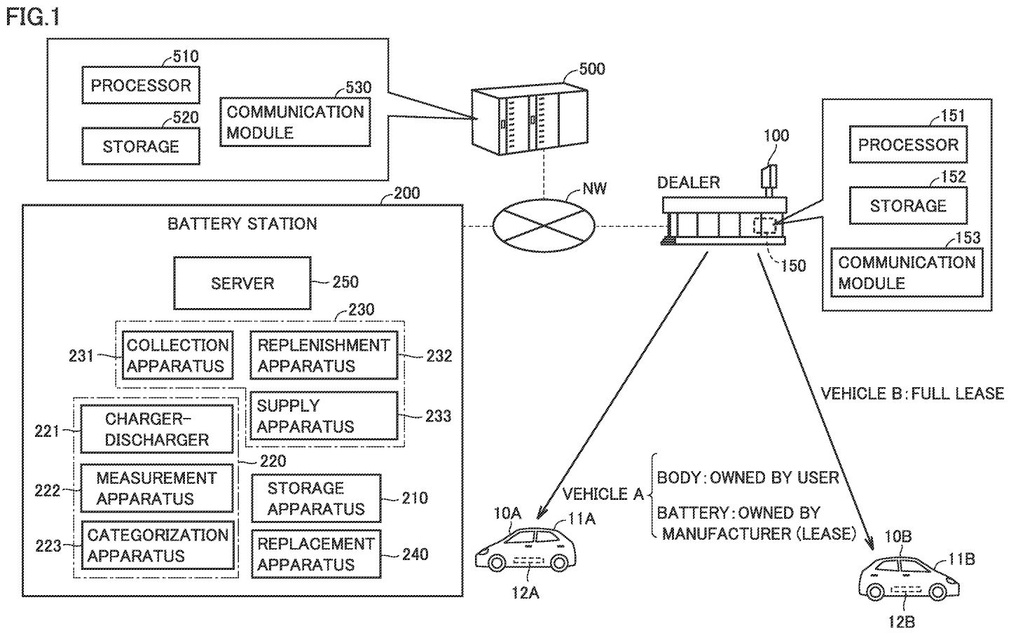

FIG. 1 is a diagram for illustrating overview of a lease system for lease of a power storage according to this embodiment. The lease system shown in FIG. 1 includes a dealer 100, a battery station (which is denoted as “BSta” below) 200, and a management center 500.

Management center 500 is a server that provides a lease service for rental of a power storage for a vehicle (for example, for an xEV), with an insurance service being added thereto. Management center 500 manages information on the lease service and the insurance service. Management center 500 belongs, for example, to an automaker. In this embodiment, the automaker serves as both of a leasing company and an insurance provider. Without being limited as such, the lease service and the insurance service may be provided by business entities different from each other. For example, a server of the leasing company and a server of the insurance provider may be in coordination with each other to provide the lease service to which the insurance service is added.

In the lease service, a plurality of lease types including a partial lease type and a full lease type are adopted. The partial lease type refers to a lease type for rental only of a power storage for a vehicle. A user who rents the power storage in accordance with the partial lease type prepares by the user himself/herself, a portion (body) of the vehicle except for the power storage. The user can mount the power storage rented from the automaker on the body owned by the user himself/herself. As the power storage is mounted on the body, the xEV can travel. When a partial lease contract is terminated, the user returns only the power storage to the automaker. The full lease type, on the other hand, refers to a lease type for rental of the entire vehicle (that is, both of a body portion and a power storage). When a full lease contract is terminated, the user returns not only the power storage but also the entire vehicle to the automaker.

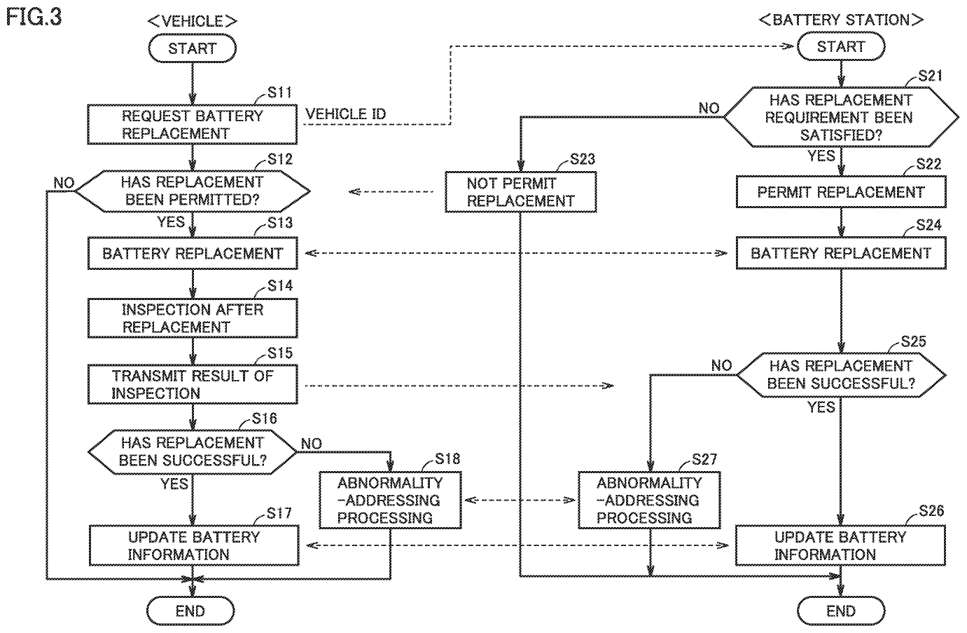

The insurance service refers to an insurance service relating to replacement of the power storage, and more particularly to a service for exemption of at least a part of compensation liability of a user who has caused deterioration or failure of a rented power storage. An insurance relating to such replacement of a power storage is also referred to as a “battery insurance” below. In this embodiment, the user is covered by the battery insurance, so that the entire compensation liability of the user for an owner of the power storage (that is, the automaker) is exempted. More specifically, the user can be provided with a substitute power storage at no charge under coverage by the battery insurance when the user has caused deterioration or failure of the rented power storage. The user can detach the deteriorated or failed power storage from the vehicle, for example, at BSta 200, and attach a new power storage (a less deteriorated power storage) provided by BSta 200 to the vehicle. The user who purchased the battery insurance, however, is not always covered by the battery insurance. The user who purchased the battery insurance can be covered by the battery insurance only when the user satisfies a prescribed replacement requirement. The replacement requirement will be described later (see S21 in FIG. 3).

Dealer 100 includes a server 150. The automaker sells or leases a vehicle through dealer 100. Dealer 100 not only sells vehicles manufactured by the automaker but also provides the lease service and the insurance service described previously. Dealer 100 rents at least one of the body and the power storage provided by the automaker. Dealer 100 may rent a power storage 12A of a vehicle 10A shown in FIG. 1 to a user, for example, in accordance with the partial lease type. In this case, vehicle 10A corresponds to the partial lease vehicle (which may be denoted as a “vehicle A” below) and a body 11A of vehicle 10A is a property of the user. Power storage 12A of vehicle 10A is provided to the user by lease and it is a property of the automaker. Alternatively, dealer 100 may rent a vehicle 10B shown in FIG. 1 to a user, for example, in accordance with the full lease type. In this case, vehicle 10B corresponds to the full lease vehicle (which may be denoted as a “vehicle B” below). The entire vehicle 10B (a body 11B and a power storage 12B) is provided to the user by lease and it is a property of the automaker.

Management center 500 includes a processor 510, a storage 520, and a communication module 530. Server 150 includes a processor 151, a storage 152, and a communication module 153. Each of processors 510 and 151 includes, for example, a central processing unit (CPU). Each of storages 520 and 152 is configured such that information put thereinto can be stored therein. Each of storages 520 and 152 may include a hard disk (HD) drive or a solid state drive (SSD). Each of communication modules 530 and 153 is connected to a communication network NW through a wire. Management center 500 and server 150 are configured to communicate with each other over communication network NW. Communication network NW is a wide range network constructed, for example, of the Internet and a wireless base station. Communication network NW may include a cellular network.

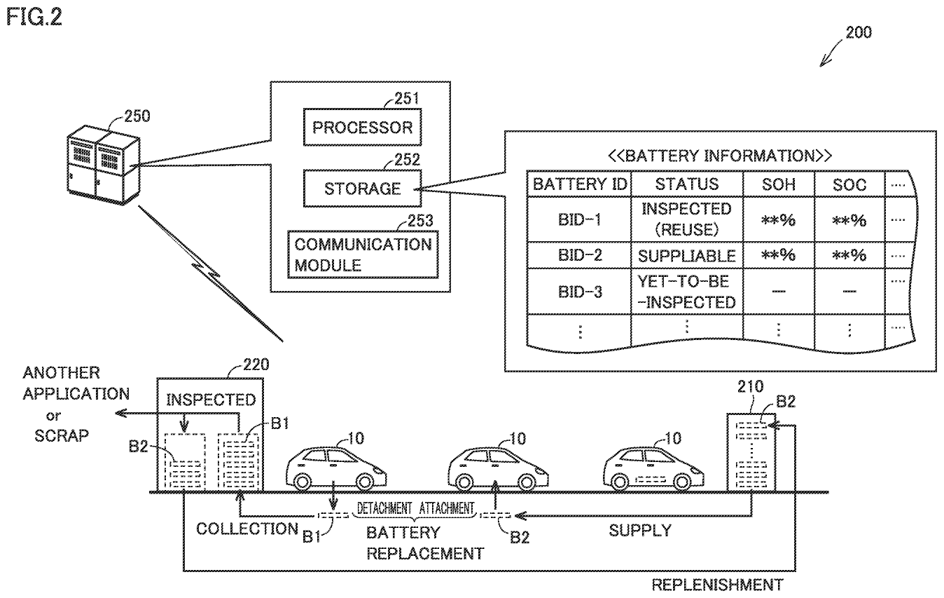

At BSta 200, a battery (power storage) mounted on a vehicle is replaced. In this embodiment, a battery (more specifically, a secondary battery) is adopted as the power storage. The power storage should only be an apparatus where electric power can be stored, and examples of the power storage include a large-capacity capacitor other than the secondary battery. BSta 200 includes a storage apparatus 210, an inspection portion 220, a conveyance portion 230, a replacement apparatus 240, and a server 250. Inspection portion 220 includes a charger-discharger 221, a measurement apparatus 222, and a categorization apparatus 223. Conveyance portion 230 includes a collection apparatus 231, a replenishment apparatus 232, and a supply apparatus 233. Details of a function of each portion of BSta 200 will be described below with reference to FIG. 2.

FIG. 2 is a diagram for illustrating a configuration and an operation of the battery station (BSta 200) according to this embodiment. A vehicle rented by dealer 100 may be referred to as a “vehicle 10” below. Vehicle 10 may be vehicle A (FIG. 1) or vehicle B (FIG. 1).

Referring to FIG. 2 together with FIG. 1, server 250 includes a processor 251, a storage 252, and a communication module 253. Processor 251 includes, for example, a CPU. Storage 252 is configured such that information put thereinto can be stored therein. Storage 252 may include an HD drive or an SSD. Communication module 253 is connected to communication network NW (FIG. 1) through a wire. Server 250 is configured to communicate with management center 500 shown in FIG. 1. Server 250 successively transmits information held therein (for example, first battery information shown below) to management center 500.

Information on each battery present in BSta 200 is stored in storage 252 of server 250, as being distinguished based on identification information (a battery ID) of the battery. The information on the battery (a first battery) present in BSta 200 is also referred to as “first battery information” below. The first battery is a property of the automaker. A new battery may be supplied from the automaker to BSta 200 or a secondhand battery collected from vehicle 10 may be stored in BSta 200.

The first battery information held by server 250 includes specifications (for example, a capacity in an initial state, charging performance, and discharging performance), a status (for example, any one of yet-to-be-inspected/inspected (reuse/another application/scrap)/suppliable), a state of health (SOH), and a state of charge (SOC).

The SOC represents a remaining amount of stored power, and expresses a ratio of a current amount of stored power to an amount of stored power in a fully charged state, for example, as 0 to 100%. The SOH represents a level of health, and a smaller SOH means a higher degree of deterioration. In this embodiment, the capacity retention rate is adopted as the SOH. The capacity retention rate of the power storage expresses a ratio of a current capacity of the power storage to the capacity of the power storage in the initial state (a state where the power storage is not deteriorated), for example, as 0 to 100%. The capacity of the power storage corresponds to the amount of stored power in the fully charged state.

At BSta 200, in response to a request from vehicle 10, the battery of vehicle 10 is replaced, for example, in a procedure as below. Server 250 is configured to wirelessly communicate with vehicle 10 and obtains battery information from vehicle 10. Server 250 and vehicle 10 may establish short-range communication, for example, through a wireless local area network (LAN) or communicate over communication network NW. At BSta 200, each of collection apparatus 231, replenishment apparatus 232, and supply apparatus 233 included in conveyance portion 230 shown in FIG. 1 is configured to convey the battery. A type of conveyance may be a conveyor type or a type with the use of a delivery robot. Replacement apparatus 240 includes a mechanism for detachment of the battery from vehicle 10 and a mechanism for attachment of the battery to vehicle 10.

Vehicle 10 is parked at a prescribed position in BSta 200, and thereafter vehicle issues a request for battery replacement to server 250. In response to this request, server 250 starts control for battery replacement. Initially, server 250 controls replacement apparatus 240 to detach the battery from vehicle 10. The battery detached from vehicle 10 is denoted as a “battery B1” below. Server 250 then selects a battery corresponding to battery B1 from among a plurality of batteries B2 accommodated in an accommodation portion (for example, a storage) of storage apparatus 210. Battery B2 corresponds to a replacement battery. Selected battery B2 is the same in specifications (for example, the capacity in the initial state, charging performance, and discharging performance) as battery B1. Battery B2 is higher in SOH than battery B1. The SOC of battery B2 is equal to or higher than a prescribed SOC value (for example, 50%).

In succession, server 250 controls supply apparatus 233 to convey battery B2 from storage apparatus 210 to replacement apparatus 240. In succession, server 250 controls replacement apparatus 240 to attach supplied battery B2 to vehicle 10. Replacement of the battery of vehicle 10 is thus completed.

BSta 200 performs a process for reuse of battery B1 detached from vehicle 10, in parallel to the battery replacement process above. The reuse process is performed, for example, in a procedure as below.

When battery B1 is detached from vehicle 10, server 250 starts control for battery reuse. Initially, server 250 controls collection apparatus 231 to convey battery B1 to inspection portion 220. In succession, server 250 controls inspection portion 220 (charger-discharger 221, measurement apparatus 222, and categorization apparatus 223) to inspect battery B1. Processing for recovery of the SOH may be performed on battery B1 before inspection. The status of battery B1 before the inspection is expressed as “yet-to-be-inspected”.

In the inspection, charger-discharger 221 has battery B1 discharged until the SOC attains to a prescribed first SOC value (for example, the SOC value indicating an empty state) and thereafter it has battery B1 charged until the SOC attains to a prescribed second SOC value (for example, the SOC value indicating the fully charged state). Measurement apparatus 222 includes various sensors, and measures a state (for example, a temperature, a current, and a voltage) of battery B1 during charging. The SOH (capacity retention rate) of battery B1 is detected based on data measured by measurement apparatus 222. A known technique may be adopted as a method of measuring each of the SOC and the SOH, and for example, at least one of a current integration method, an open circuit voltage (OCV) estimation method, an equivalent circuit model method, and a non-linear Kalman filter method may be adopted.

Categorization apparatus 223 categorizes battery B1 into a battery for reuse as a vehicle battery, a battery for use in another application (an application other than the application for the vehicle), and scrap, in accordance with a result of the inspection. The statuses of battery B1 categorized into “reuse as a vehicle battery,” “use in another application,” and “scrap” are expressed as “inspected (reuse),” “inspected (another application),” and “inspected (scrap).” Categorization apparatus 223 may categorize battery B1 having the SOH less than a first reference value into the inspected (scrap), categorize battery B1 having the SOH not less than the first reference value and less than a second reference value into inspected (another application), and categorize battery B1 having the SOH equal to or more than the second reference value into inspected (reuse). The second reference value is larger than BTh (a replacement threshold value) which will be described later. Battery B1 of the status “inspected (another application)” is shipped for another application. Examples of another application include stationary use. Battery B1 of the status “inspected (scrap)” is scrapped. In a scrap process, however, the battery may be disassembled to a material level to collect a recyclable material (resource) for reuse of the material (resource recycle). Measurement apparatus 222 may further include a camera for inspection of an appearance. Categorization apparatus 223 may categorize battery B1 having a significantly damaged appearance into a non-reusable battery (another application or scrap).

Battery B1 of the status “inspected (reuse)” is handled as battery B2 (replacement battery) described previously. After the inspection, server 250 controls replenishment apparatus 232 to convey battery B2 (battery B1 of “inspected (reuse)”) to storage apparatus 210. Storage apparatus 210 is replenished with conveyed battery B2. Inspected and charged battery B2 is thus set in storage apparatus 210. Without being limited as such, storage apparatus 210 may be configured to charge inspected battery B2. The status of battery B2 set in storage apparatus 210 is “suppliable”.

FIG. 2 shows an example where detachment of the battery and attachment of the battery are performed at different locations. Vehicle 10 may be conveyed from a detachment position to an attachment position by a not-shown conveyance apparatus (for example, a conveyance apparatus of a conveyor type). Without being limited as such, detachment of the battery and attachment of the battery may be performed at the same location. The battery may be replaced (detached and attached) while vehicle 10 is at a standstill (for example, a parked state).

FIG. 3 is a flowchart showing processing involved with battery replacement performed by vehicle 10 and a terminal (server 250) at the battery station. Each step in the flowchart is simply denoted as “S” below.

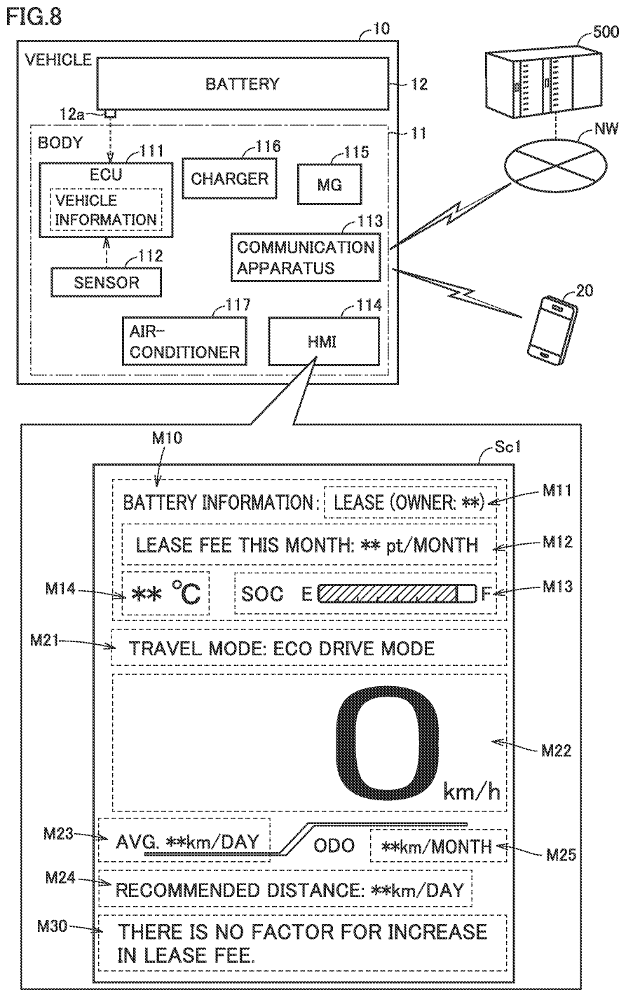

Referring to FIG. 3 together with FIG. 2, a series of processing from 511 to S18 is performed by vehicle 10 (for example, an ECU 111 shown in FIG. 8 which will be described later). A series of processing from S21 to S27 is performed by server 250. Vehicle 10 arrives at BSta 200, and thereafter in S11, it transmits a signal requesting battery replacement (which is also referred to as a “replacement request signal” below) to BSta 200. In the series of processing shown in FIG. 3, vehicle 10 that requests battery replacement is referred to as a “subject vehicle.” The replacement request signal includes identification information (a vehicle ID) of the subject vehicle. Vehicle 10 may request battery replacement (S11) in response to an instruction from a user.

In S21, server 250 that has received the replacement request signal determines whether or not a prescribed replacement requirement in connection with the subject vehicle is satisfied. Specifically, server 250 obtains information on the subject vehicle from management center 500 based on the vehicle ID. Server 250 then determines whether or not the replacement requirement is satisfied based on the information obtained from management center 500.

In this embodiment, when a prescribed exclusion requirement is satisfied, the replacement requirement is not satisfied. In other words, dissatisfaction of the exclusion requirement is a necessary condition for satisfaction of the replacement requirement. For example, when the user has intentionally caused deterioration or failure of the battery, the exclusion requirement is satisfied. In this embodiment, when management center 500 receives a report (a fraud report) that the user of the subject vehicle has intentionally caused deterioration or failure of the battery, the exclusion requirement is satisfied, and when management center 500 does not receive the fraud report, the exclusion requirement is not satisfied. When the exclusion requirement is not satisfied and management center 500 receives a report (an accident report) that the subject vehicle has been involved in an accident, the replacement requirement is satisfied. For vehicle A shown in FIG. 1, when the exclusion requirement is not satisfied and the capacity retention rate of power storage 12A mounted on vehicle A (subject vehicle) becomes equal to or less than a prescribed replacement threshold value (BTh which will be described later) as well, the replacement requirement is satisfied.

When the replacement requirement is satisfied in connection with the subject vehicle (YES in S21), in S22, server 250 sends a notification indicating permission to the subject vehicle, and thereafter the process proceeds to S24. When the replacement requirement is not satisfied in connection with the subject vehicle (NO in S21), on the other hand, in 523, server 250 sends a notification indicating non-permission to the subject vehicle, and thereafter the series of processing from S21 to S27 ends. In this case, the battery is not replaced.

The subject vehicle transmits the replacement request signal (S11), and thereafter it waits for reply from server 250. When the subject vehicle receives the reply from server 250, in S12, it determines whether or not replacement of the battery has been permitted. When the subject vehicle receives the notification indicating permission (YES in S12), the process proceeds to S13. When the subject vehicle receives the notification indicating non-permission (NO in S12), on the other hand, the series of processing from S11 to S18 ends. In this case, the battery is not replaced.

In S13 and S24, the battery is replaced in the procedure described previously (see FIG. 2). The subject vehicle and server 250 exchange information for replacement of the battery. Server 250 obtains information (for example, specifications) on the battery mounted on the subject vehicle from the subject vehicle.

When replacement of the battery is completed, in 514, the subject vehicle inspects battery B2 (FIG. 2) attached to the vehicle. In succession, in S15, the subject vehicle transmits a result of inspection to server 250. In succession, in S16, the subject vehicle determines whether or not the battery has successfully been replaced in accordance with the result of inspection. The subject vehicle determines that the battery has successfully been replaced unless abnormality (for example, defective connection or abnormal electrical performance) is found in the inspection, and determines that replacement of the battery has failed when abnormality is found in the inspection. Similarly, in S25, server 250 that has received the result of inspection also determines whether or not the battery has successfully been replaced in accordance with the result of inspection (normal/abnormal).

When the battery has successfully been replaced (YES in S16 and YES in S25), the subject vehicle and server 250 update the battery information held therein in S17 and S26, respectively, and thereafter the series of processing shown in FIG. 3 ends. When replacement of the battery has failed (NO in S16 and NO in S25), on the other hand, the subject vehicle and server 250 perform prescribed abnormality-addressing processing in S18 and S27, respectively. The abnormality-addressing processing may include processing for notifying the user of the subject vehicle of failure in replacement of the battery. The abnormality-addressing processing may include processing for notifying management center 500 of failure in replacement of the battery. The abnormality-addressing processing may include processing for once detaching battery B2 (FIG. 2) attached to the subject vehicle from the subject vehicle and redoing replacement of the battery. After the abnormality-addressing processing is performed, the series of processing shown in FIG. 3 ends. The abnormality-addressing processing can freely be set.

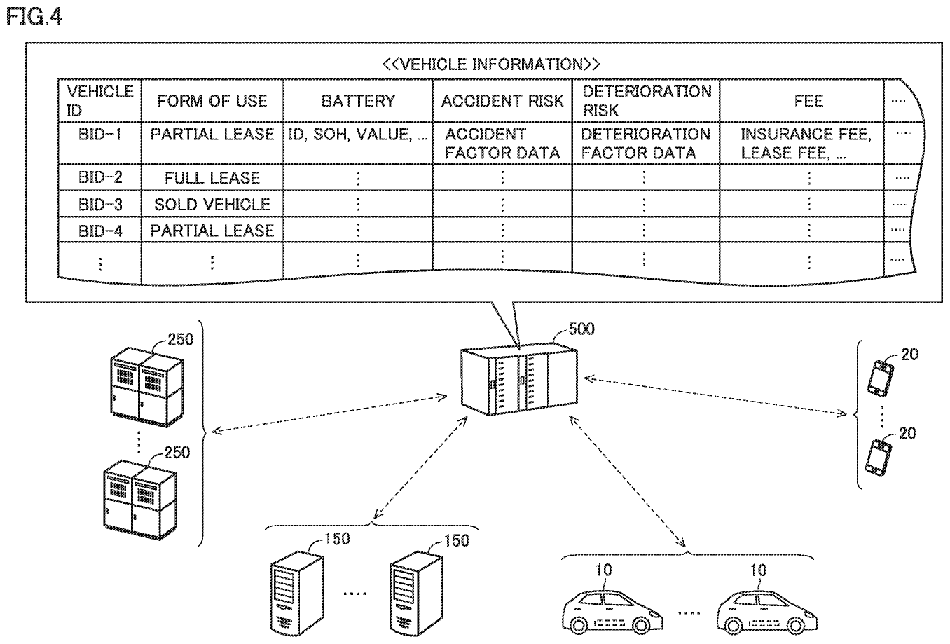

FIG. 4 is a diagram for illustrating information managed by management center 500 according to this embodiment.

Referring to FIG. 4, identification information (vehicle ID) of each vehicle sold or leased by dealer 100 is registered in advance in management center 500. The vehicle ID may be a vehicle identification number (VIN). Information on each vehicle (which is also referred to as “vehicle information” below) is stored in storage 520 of management center 500, as being distinguished based on the vehicle ID. A latest value of a parameter that varies over time in the vehicle information is successively transmitted from each sold or leased vehicle to management center 500, and transition of the value of the parameter is recorded in management center 500. Management center 500 then manages recorded data as being distinguished in accordance with a unit period (for example, one month) corresponding to a period of coverage by the insurance service so that the data for each unit period can be obtained.

The vehicle information includes use form information, second battery information, accident risk information, deterioration risk information, fee information, and presence/absence of various reports. The various reports include the fraud report and the accident report described previously.

The use form information represents a form of use of the vehicle. In this embodiment, the use form information represents the form of use of any of a sold vehicle (sold vehicle), vehicle A (partial lease vehicle), and vehicle B (full lease vehicle).

In this embodiment, the automaker (management center 500) provides an insurance service relating to repair of the body in addition to the insurance service relating to replacement of the power storage described previously. The insurance service relating to repair of the body is a service to exempt at least a part of compensation liability of the user who has caused damage or failure of the rented body. Such an insurance relating to repair of the body is also referred to as a “body insurance” below. In this embodiment, the user of vehicle A purchases the battery insurance but does not purchase the body insurance. The user of vehicle B purchases both of the battery insurance and the body insurance. Since the battery insurance and the body insurance are insurances directed to lease, a user of a sold vehicle purchases neither of the battery insurance and the body insurance.

The second battery information corresponds to information on the battery (a second battery) mounted on the vehicle. The second battery information includes a battery ID, specifications (for example, the capacity in the initial state, charging performance, and discharging performance), and the SOH.

The accident risk information corresponds to information on an accident risk of the vehicle. The accident risk information represents various accident factor parameters and accident risks in accordance with such accident factor parameters.

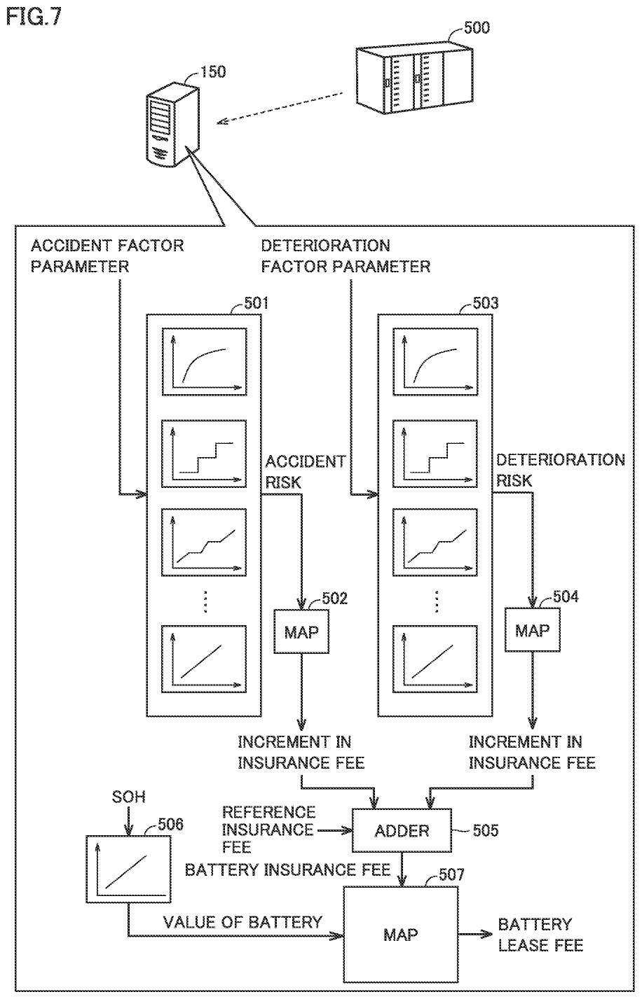

The accident risk represents possibility that the vehicle may be involved in an accident in the future. A lower accident risk of the vehicle means lower possibility that the vehicle may be involved in an accident. A specific example of the accident factor parameter will be described later (see FIG. 7).

The deterioration risk information corresponds to information on a deterioration risk of the second battery. The deterioration risk information represents various deterioration factor parameters and deterioration risks in accordance with the deterioration factor parameters. The deterioration risk represents possibility of deterioration of the power storage in the future. A lower deterioration risk of the power storage means lower possibility of deterioration of the power storage. A specific example of the deterioration factor parameter will be described later (see FIG. 7).

The fee information corresponds to information on a fee paid by a vehicle user to the automaker. The fee information includes an insurance fee and a lease fee. The insurance fee includes a battery insurance fee. The battery insurance fee corresponds to a fee paid for reception by the vehicle user of the insurance service relating to replacement of the battery. The lease fee includes a battery lease fee. The battery lease fee corresponds to a fee paid by the vehicle user for rental use of the battery from an owner of the battery. In this embodiment, the fee is counted as the number of points (pt). A large number of points means a high fee. The point may be handled as a virtual currency or converted to a general currency (for example, dollar, renminbi, won, or yen). The point may be converted to an item or a right (for example, a right to receive a service in conformity with the number of points).

The lease system according to this embodiment includes a plurality of dealers 100 (each including server 150), a plurality of BSta's 200 (each including server 250), and a plurality of vehicles 10. The lease system further includes a plurality of portable terminals 20 carried by users of vehicles 10. Management center 500 is configured to communicate with each of server 150 of dealer 100 provided at each point and server 250 at the battery station (BSta 200) provided at each point. Management center 500 is configured to communicate also with each vehicle 10 sold or leased by any dealer 100 and portable terminal 20 corresponding to each vehicle 10.

Portable terminal 20 is configured as being portable by the user. Portable terminal 20 is operated while it is carried by the user (vehicle manager) of vehicle 10. In this embodiment, a smartphone equipped with a touch panel display is adopted as portable terminal 20. The smartphone contains a computer and performs a speaker function. Without being limited as such, any terminal portable by the user of vehicle can be adopted as portable terminal 20. For example, a laptop computer, a tablet terminal, a portable game console, a wearable device (a smartwatch, smartglasses, smart gloves, or the like), and an electronic key can also be adopted as portable terminal 20.

Application software (which is referred to as a “mobile app” below) for using a service provided by management center 500 is installed in portable terminal 20. With the mobile app, identification information (a terminal ID) of portable terminal 20 is registered in management center 500 in association with identification information (a vehicle ID) of corresponding vehicle 10. Portable terminal 20 can exchange information with management center 500 through the mobile app.

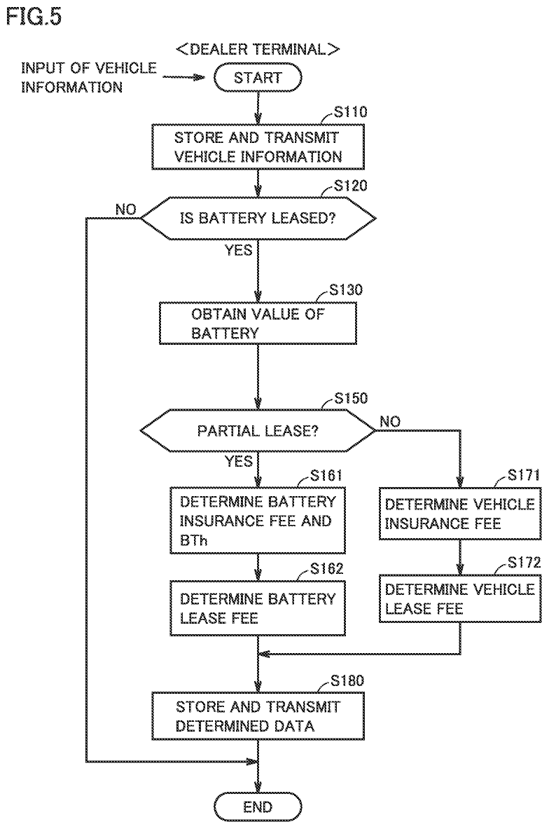

When dealer 100 sells or leases the vehicle, information on the vehicle (for example, the vehicle information shown in FIG. 4) is inputted to server 150. The use form information and the second battery information are thus stored in storage 152 of server 150. For information that has not been set in the initial state in the vehicle information (FIG. 4) described previously, a predetermined initial value may be set. Thereafter, the vehicle information stored in storage 152 is updated in a series of processing shown in FIG. 5 which will be described below. For example, a lease fee of a leased vehicle is determined in the series of processing shown in FIG. 5.

FIG. 5 is a flowchart showing processing performed by server 150 (a dealer terminal) at the time of registration of a new vehicle. The processing shown in this flowchart is performed when information on the new vehicle is inputted to server 150.

Referring to FIG. 5, in S110, inputted vehicle information is stored in storage 152 of server 150 and server 150 transmits the vehicle information to management center 500. In S120, server 150 determines whether or not the battery of the vehicle has been leased based on the use form information included in the vehicle information. When the vehicle falls under the sold vehicle (NO in S120), the series of processing shown in FIG. 5 ends without processing in S130 or later being performed. When the vehicle falls under vehicle A or vehicle B (YES in S120), on the other hand, the process proceeds to 5130.

In S130, server 150 obtains a value of the battery mounted on the vehicle based on the SOH (capacity retention rate). In this embodiment, the battery at the time of start of lease is new (SOH=100%). Without being limited as such, the battery at the time of start of lease may be secondhand (SOH<100%).

In succession, in S150, server 150 determines whether or not the vehicle falls under vehicle A (partial lease vehicle) based on the use form information described previously. When the vehicle falls under vehicle A (YES in S150), in S161, server 150 determines the battery insurance fee (the insurance fee for the battery insurance) and a threshold value (which is denoted as “BTh” below) for replacement of the battery.

Specifically, server 150 determines the battery insurance fee based on the accident risk and the deterioration risk. How to obtain these risks and a method of determining the insurance fee will be described later (see FIG. 7). BTh in 5161 represents timing of battery replacement. BTh is set to avoid excessive deterioration of the battery. BTh may be fixed or variable. In this embodiment, in S161, server 150 sets higher BTh as the deterioration risk of the battery is higher. As the deterioration risk is higher, a rate of deterioration of the battery is higher, and as BTh is higher, the battery tends to be replaced earlier. Since BTh is higher as the deterioration risk of the battery is higher, excessive deterioration of the battery can be suppressed.

After processing in S161, in S162, server 150 determines the battery lease fee. Though details will be described later, server 150 determines the battery lease fee based on the value of the battery (S130) and the battery insurance fee (S161). Thereafter, the process proceeds to S180.

When the vehicle falls under vehicle B (full lease vehicle) (NO in S150), in S171, server 150 determines the vehicle insurance fee only based on the accident risk, of the accident risk and the deterioration risk. The vehicle insurance fee is a total amount, for example, of the battery insurance fee and the body insurance fee (the insurance fee for the body insurance). In succession, in S172, server 150 determines a vehicle lease fee. The vehicle lease fee is a total amount, for example, of the battery lease fee and a body lease fee. Thereafter, the process proceeds to S180. Details of a method of determining the insurance fee and the lease fee will be described later (see FIG. 7).

In S180, data determined in the processing described above is stored in storage 152 of server 150 and server 150 transmits the data to management center 500. Specifically, for vehicle A, the value of the battery, the accident risk, the deterioration risk, the battery insurance fee, BTh (replacement threshold value), and the battery lease fee are transmitted. For vehicle B, the value of the battery, the accident risk, the vehicle insurance fee, and the vehicle lease fee are transmitted.

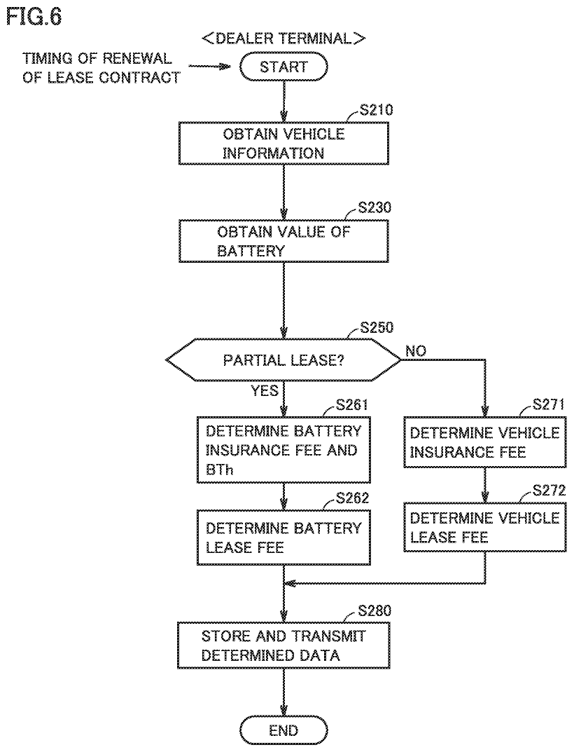

FIG. 6 is a flowchart showing processing involved with determination of the lease fee at the time of renewal of a lease contract. Processing shown in this flowchart is performed by server 150 when timing to renew the lease contract comes. Unless a contractor (for example, a vehicle user) shows its intention for cancellation, each time a period during which the lease service and the insurance service are effective (which is also referred to as a “lease period” below) elapses, contract contents (including the lease fee) for a next lease period are determined, and the lease contract is automatically renewed. In this embodiment, a length (unit period) of the lease period is set to one month.

Server 150 determines the lease fee (including the insurance fee) for the lease period based on data during an assessment period preceding the lease period, in a series of processing shown in FIG. 6 which will be described below. In this embodiment, a month preceding the lease period (one month immediately before the lease period) is defined as the assessment period. Server 150 performs the series of processing shown in FIG. 6, for example, at timing of start of a next lease period after lapse of the lease period. The lease period that has elapsed corresponds to the assessment period for the next lease period. In the series of processing shown in FIG. 6, a vehicle rented based on the renewed lease contract is referred to as a “subject vehicle.” The subject vehicle is any of vehicles A and B (FIG. 1).

Referring to FIG. 6, in S210, server 150 obtains information on the subject vehicle (vehicle information) based on the identification information (vehicle ID) of the subject vehicle from management center 500 or from the subject vehicle.

In following S230, S250, S261, S262, S271, S272, and S280, processing in accordance with S130, S150, S161, S162, S171, S172, and S180 shown in FIG. 5 is performed. Specifically, in S230, server 150 obtains the value of the battery mounted on the subject vehicle based on the SOH (capacity retention rate) at the current time point. In S250, server 150 determines whether or not the subject vehicle falls under vehicle A (partial lease vehicle) based on the use form information.

When the subject vehicle falls under vehicle A (YES in S250), in S261, server 150 determines the battery insurance fee and BTh. Specifically, server 150 determines the battery insurance fee based on the accident risk and the deterioration risk assessed based on the accident factor parameter and the deterioration factor parameter during the assessment period. Server 150 sets higher BTh as the deterioration risk assessed based on the deterioration factor parameter during the assessment period is higher. In succession, in S262, server 150 determines the battery lease fee. Thereafter, the process proceeds to S280.

When the subject vehicle falls under vehicle B (full lease vehicle) (NO in S250), in S271, server 150 determines the vehicle insurance fee based on the accident risk assessed based on the accident factor parameter during the assessment period. In succession, in S272, server 150 determines the vehicle lease fee. Thereafter, the process proceeds to S280.

In S280, as in S180 in FIG. 5, data determined in S230, S261, S262, S271, and S272 is stored in storage 152 of server 150 and server 150 transmits the data to management center 500.

FIG. 7 is a diagram for illustrating a method of determining the insurance fee and the lease fee. Referring to FIG. 7, maps 501 to 504, 506, and 507 are stored in storage 152 of server 150. Server 150 includes an adder 505. Adder 505 may be implemented by a program or electronic circuitry.

Map 501 includes a plurality of maps. A map is prepared for each accident factor parameter. Each of these maps defines such relation that the accident risk is higher as the accident factor parameter is larger. In the relation defined in each map, the accident risk continuously or intermittently becomes higher with increase in accident factor parameter. When a value of the accident factor parameter is inputted to each map, the map outputs an increment in accident risk originating from the accident factor parameter. Map 501 obtains the increment in accident risk for each accident factor parameter, and outputs the accident risk including all increments originating from these accident factor parameters.

In this embodiment, a cumulative travel distance or a cumulative time period of travel (which are collectively referred to as a “comprehensive travel frequency” below) of the subject vehicle, a distance or a time period of travel of the subject vehicle in a congested environment (which is also collectively referred to as a “congestion travel frequency” below), a distance or a time period of travel of the subject vehicle in a later-described sport drive mode (which is collectively referred to as a “sport travel frequency” below), and a distance or a time period of travel of the subject vehicle in a cold area (which is collectively referred to as a “cold area travel frequency” below) are adopted as the accident factor parameters. Each of the comprehensive travel frequency, the congestion travel frequency, the sport travel frequency, and the cold area travel frequency corresponds to exemplary “travel data” according to the present disclosure. Map 501 outputs the accident risk which is lower as the comprehensive travel frequency is lower. Map 501 outputs the accident risk which is lower as the congestion travel frequency is lower. Map 501 outputs the accident risk which is lower as the sport travel frequency is lower. Map 501 outputs the accident risk which is lower as the cold area travel frequency is lower. Server 150 obtains a value of each accident factor parameter in connection with the subject vehicle from management center 500 or the subject vehicle.

The accident risk outputted from map 501 may be expressed by a value calculated by addition of an increment in risk originating from the accident factor parameter to a reference value of the accident risk. The reference value of the accident risk may be a standard accident risk (for example, an average value of all users) or “0”. The accident risk outputted from map 501 is inputted to map 502. Map 502 then outputs an increment in insurance fee in accordance with the inputted accident risk. Map 502 defines such relation that the insurance fee is higher as the accident risk is higher. Map 502 outputs to adder 505, the increment in insurance fee which is larger as the accident risk inputted from map 501 is higher.

Map 503 includes a plurality of maps. The map is prepared for each deterioration factor parameter. Each of these maps defines such relation that the deterioration risk is higher as the deterioration factor parameter is larger. In the relation defined in each map, the deterioration risk continuously or intermittently becomes higher with increase in deterioration factor parameter. When a value of the deterioration factor parameter is inputted to each map, the map outputs an increment in deterioration risk originating from the deterioration factor parameter. Map 503 obtains the increment in deterioration risk for each deterioration factor parameter, and outputs the deterioration risk including all increments originating from these deterioration factor parameters.

In this embodiment, the comprehensive travel frequency, the congestion travel frequency, the sport travel frequency, the cold area travel frequency, a time period during which an air-conditioning apparatus mounted on the subject vehicle operates in a later-described manual mode (which is referred to as a “manual air-conditioning time period” below), and a time period during which the SOC of the battery mounted on the subject vehicle is equal to or more than a deterioration threshold value (which is referred to as a “high SOC time period” below) are adopted as the deterioration factor parameters. The deterioration threshold value corresponds to a lower limit value of a high SOC region where deterioration of the battery is accelerated. The deterioration threshold value may be set, for example, to approximately 80%. Map 503 outputs the deterioration risk which is lower as the comprehensive travel frequency is lower. Map 503 outputs the deterioration risk which is lower as the congestion travel frequency is lower. Map 503 outputs the deterioration risk which is lower as the sport travel frequency is lower. Map 503 outputs the deterioration risk which is lower as the cold area travel frequency is lower. Map 503 outputs the deterioration risk which is lower as the manual air-conditioning time period is shorter. Map 503 outputs the deterioration risk which is lower as the high SOC time period is shorter. Server 150 obtains a value of each deterioration factor parameter in connection with the subject vehicle from management center 500 or the subject vehicle.

The deterioration risk outputted from map 503 may be expressed by a value calculated by addition of an increment in risk originating from the deterioration factor parameter to a reference value of the deterioration risk. The reference value of the deterioration risk may be a standard deterioration risk (for example, an average value of all users) or “0”. The deterioration risk outputted from map 503 is inputted to map 504. Map 504 then outputs an increment in insurance fee in accordance with the inputted deterioration risk. Map 504 defines such relation that the insurance fee is higher as the deterioration risk is higher. Map 504 outputs to adder 505, the increment in insurance fee which is larger as the deterioration risk inputted from map 503 is higher.

Adder 505 outputs as the battery insurance fee, a value resulting from addition of a prescribed reference insurance fee, the increment in insurance fee inputted from map 502, and the increment in insurance fee inputted from map 504 to map 507.

When map 506 receives input of the value of the SOH (capacity retention rate) of the battery, it outputs the value of the battery in accordance with the SOH. Map 506 defines such relation that the value of the battery is lower as the SOH is lower. Server 150 obtains the value of the SOH of the battery in connection with the subject vehicle from management center 500 or the subject vehicle and inputs the value to map 506. Map 506 outputs the value of the battery in accordance with the SOH to map 507. In this embodiment, server 150 assesses the value of the battery based only on the SOH (capacity retention rate). Without being limited as such, server 150 may assess the value of the battery mounted on the subject vehicle further based on another type of information (for example, an assessed price of the battery in markets) in addition to the SOH.

Map 507 defines relation among the value of the battery, the battery insurance fee, and the battery lease fee. Map 507 outputs the battery lease fee which is higher as the value of the battery is higher or the battery insurance fee is higher. Map 507 outputs, for example, a value calculated by addition of the value (pt/month) of the battery inputted from map 506 and the battery insurance fee (pt/month) inputted from adder 505 as the battery lease fee (pt/month). In this embodiment, map 507 functions as the adder. Without being limited as such, map 507 may calculate the battery lease fee in accordance with the value of the battery and the insurance fee, in a complicated relational expression including various coefficients.

In the processing shown in FIGS. 5 and 6, in S130 and S230, server 150 obtains the value of the battery in accordance with the SOH at the current time point with the use of map 506.

In S161 and S261, the insurance fee for the partial lease vehicle is determined. The partial lease vehicle according to this embodiment is used for a long period of time by replacement of the battery thereof each time the battery deteriorates. The battery may be replaced before (for example, immediately before) the battery deteriorates to such an extent as causing disadvantage in reuse thereof following replacement. Alternatively, the battery may be replaced before (for example, immediately before) the battery deteriorates to such an extent as causing disadvantage in continued use thereof. An accident may also necessitate replacement of the battery. For example, when the vehicle passes over an object placed on the road, the object may collide with the battery located in a lower portion of the vehicle (for example, under the floor), which may damage the battery. In S161 and S261, server 150 determines the battery insurance fee in accordance with the accident risk and the deterioration risk with the use of maps 501 to 504 and adder 505. More specifically, in S261, server 150 inputs the value of the accident factor parameter (for example, the comprehensive travel frequency, the congestion travel frequency, the sport travel frequency, and the cold area travel frequency) during the assessment period to map 501 and inputs the value of the deterioration factor parameter (for example, the comprehensive travel frequency, the congestion travel frequency, the sport travel frequency, the cold area travel frequency, the manual air-conditioning time period, and the high SOC time period) during the assessment period to map 503, to thereby obtain the battery insurance fee to be paid by the user for the next lease period. At the time of start of lease, however, travel data and battery data for obtaining the accident risk and the deterioration risk have not been accumulated in the subject vehicle. Therefore, in S161, server 150 may obtain the battery insurance fee based on history data (the accident factor parameter and the deterioration factor parameter) of another vehicle used by the user of the subject vehicle in the past. Alternatively, server 150 may set each of the accident risk and the deterioration risk to the reference value described previously and obtain the battery insurance fee based on the set accident risk and deterioration risk.

In S162 and S262, the battery lease fee for the partial lease vehicle is determined. In S162 and S262, server 150 determines the battery lease fee in accordance with the value of the battery and the battery insurance fee with the use of map 507.

In S171 and S271, the insurance fee for the full lease vehicle is determined. The full lease vehicle according to this embodiment is returned to the owner of the vehicle (for example, the automaker) before the battery deteriorates to such an extent as causing disadvantage in continued use thereof. An accident, however, may necessitate replacement of the battery. In S171 and S271, server 150 obtains the battery insurance fee based on the accident risk and adds the body insurance fee to the obtained battery insurance fee, to thereby determine the vehicle insurance fee. The body insurance fee may be fixed or variable depending on the accident risk. In S171 and S271, server 150 determines the battery insurance fee without the use of the deterioration risk. More specifically, in S271, server 150 obtains the battery insurance fee to be paid by the user for the next lease period by inputting the value of the accident factor parameter during the assessment period to map 501. In S171, server 150 may obtain the accident risk at the time of start of lease with the method the same as in S161 described previously.

In S172 and S272, the lease fee for the full lease vehicle is determined. In S172 and S272, server 150 obtains the battery lease fee in accordance with the value of the battery and the battery insurance fee with the use of map 507 and adds the body lease fee to the obtained battery lease fee, to thereby determine the vehicle lease fee. The body lease fee may be a total of the value of the body and the body insurance fee. Server 150 may calculate the value of the body, for example, by subtracting the value of the battery in the initial state from an assessed price of the vehicle in the markets.

In this embodiment, not only server 150 (dealer terminal) but also management center 500 includes each map shown in FIG. 7. These maps are stored in storage 520. Each map shown in FIG. 7 should only define relation between an input value and an output value, or it may be expressed in a mathematical expression. Management center 500 may be configured to update maps 502, 504, and 507 in each of the plurality of dealers 100 by communicating with each dealer 100. The automaker (insurance provider) can thus readily revise the insurance fee. Management center 500 may simultaneously update the maps in all dealers 100 under the management thereby such that all dealers under the management thereby use the same map (common map). Management center 500 may transmit a new reference insurance fee to each dealer 100 when it changes the reference insurance fee.

FIG. 8 is a diagram for illustrating a configuration of vehicle 10. Referring to FIG. 8, vehicle 10 includes a body 11 and a battery 12. Vehicle 10 is configured to travel with electric power stored in battery 12. Vehicle 10 is, for example, a BEV not provided with an internal combustion engine. A known power storage for a vehicle (for example, a liquid secondary battery, an all-solid-state secondary battery, or a battery pack) can be adopted as battery 12. Examples of the secondary battery for the vehicle include a lithium ion battery and a nickel metal hydride battery. Battery 12 is provided with a battery management system (BMS) 12a that detects a state of battery 12. Battery 12 corresponds to an exemplary “power storage” according to the present disclosure.

Body 11 includes an electronic control unit (which is referred to as an “ECU” below) 111, a sensor group 112, a communication apparatus 113, a human machine interface (HMI) 114, a motor generator (MG) 115, a charger 116, and an air-conditioning apparatus (which is referred to as an “air-conditioner (A/C)” below) 117.

A microcomputer including a processor, a random access memory (RAM), and a storage can be adopted as ECU 111. Sensor group 112 includes various sensors (for example, a position sensor, a vehicle speed sensor, an accelerator sensor, an odometer, and an outdoor temperature sensor) mounted on body 11. Detection values from these sensors are inputted to ECU 111. ECU 111 obtains a state (for example, a temperature, a current, a voltage, an SOC, and an SOH) of battery 12 based on an output from BMS 1a. Vehicle information obtained by ECU 111 is stored in the storage.

ECU 111 performs a time counting function. ECU 111 measures in real time, the cumulative time period of travel, the time period of travel in the congested environment, the time period of travel in the sport drive mode, the time period of travel in the cold area, the manual air-conditioning time period, and the high SOC time period described previously and has a measured value of each parameter successively recorded in the storage in association with time. ECU 111 measures in real time, a travel distance (for example, the cumulative travel distance, the travel distance in the congested environment, the travel distance in the sport drive mode, and the travel distance in the cold area described previously) with the use of the odometer and has a measured value of each parameter successively recorded in the storage in association with time. Travel in the congested environment may be travel during the commuting rush hour. ECU 111 may determine whether or not vehicle 10 is traveling during the commuting rush hour based on whether or not vehicle 10 travels in a prescribed time frame (a time frame during which the commuting rush occurs). ECU 111 may measure a degree of congestion (for example, the number of other vehicles per unit distance or a time period spent by vehicle 10 to travel a unit distance) in an environment where vehicle 10 is traveling and determine whether or not vehicle 10 is traveling in the congested environment based on whether or not the measured degree of congestion is equal to or more than a prescribed value. ECU 111 may determine whether or not vehicle 10 is traveling in the cold area based on an outdoor temperature or a battery temperature.

Communication apparatus 113 includes a communication interface (I/F) for access to communication network NW through wireless communication. Communication apparatus 113 may include a telematics control unit (TCU) and/or a data communication module (DCM) for wireless communication. Communication apparatus 113 further includes a communication OF for wireless communication with each of server 250 (FIG. 2) and portable terminal 20. ECU 111 is configured to communicate with each of management center 500, server 250, and portable terminal through communication apparatus 113. ECU 111 may communicate with server 150 through communication apparatus 113.

HMI 114 includes an input device and a display device. The input device accepts an input from a user. The input device may include an operation panel. HMI 114 may include a touch panel display. In this embodiment, HMI 114 includes a meter panel. HMI 114 may further include a navigation system and a head-up display. HMI 114 may include a smart speaker that accepts an audio input.

MG 115 functions as a motor for travel. MG 115 drives a drive wheel of vehicle 10 with electric power from battery 12 in a power running state and performs regenerative charging of battery 12 in a power generating state. Charger 116 functions as a charger for external charging of battery 12 (that is, charging of battery 12 with electric power from the outside of the vehicle). MG 115 and charger 116 are controlled by ECU 111.

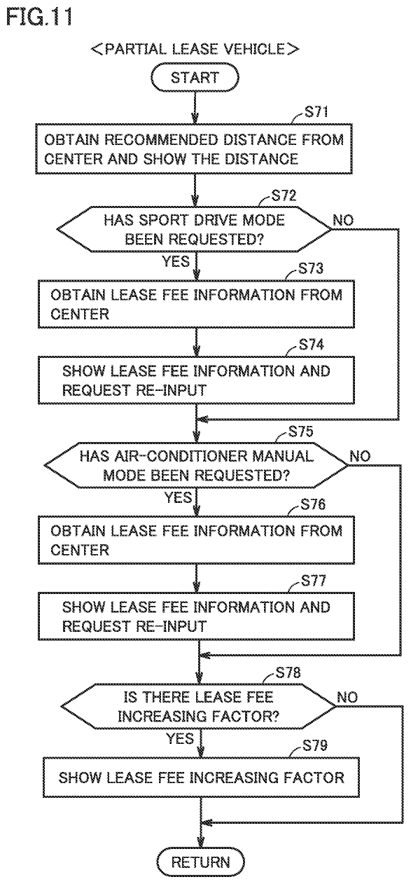

Air-conditioner 117 is configured to perform air-conditioning (for example, adjustment of a temperature) in a compartment of vehicle 10. Air-conditioner 117 is configured to operate in a manual mode and an automatic mode. The manual mode refers to a mode in which air-conditioner 117 operates in accordance with an operation by a user. The automatic mode refers to a mode in which ECU 111 controls air-conditioner 117 without depending on an operation by the user. In the automatic mode, air-conditioner 117 is controlled, for example, to improve electric power consumption (a rate of consumption of electric power). Air-conditioner 117 switches between these modes in accordance with an input from the user. When air-conditioner 117 is requested to operate in the manual mode by the user, it transmits a signal to that effect to ECU 111. Only when ECU 111 permits the operation in the manual mode, air-conditioner 117 operates in the manual mode (see S77 in FIG. 11 which will be described later).

Vehicle 10 is configured to travel in a standard mode, an eco drive mode, and the sport drive mode. ECU 111 switches a drive mode, for example, in accordance with an input from the user. The eco drive mode refers to a drive mode where MG 115 is controlled with electric power consumption being prioritized over quick acceleration. The sport drive mode refers to a drive mode where MG 115 is controlled with quick acceleration being prioritized over electric power consumption. The standard mode refers to a drive mode where MG 115 is controlled with quick acceleration and electric power consumption being balanced. Though the eco drive mode is superior in electric power consumption to the standard mode, it is inferior thereto in quick acceleration. Though the sport drive mode is superior in quick acceleration to the standard mode, it is inferior thereto in electric power consumption. In the sport drive mode, output power from MG 115 is more readily increased.

In this embodiment, each of HMI 114 and portable terminal 20 functions as a user terminal of vehicle 10. While a vehicle system (a control system including ECU 11) is active, for example, a screen Sc1 is always shown on the meter panel (HMI 114) of vehicle 10. Screen Sc1 includes display sections M10, M21 to M25, and M30. Information on battery 12 is shown in display section M10.

Display section M10 includes a section M11 where a form of use (for example, lease) of battery 12 is shown, a section M12 where the lease fee of this month is shown, and sections M13 and M14 where the current SOC and the current temperature of battery 12 are shown, respectively. In an example where battery 12 is leased, identification information (for example, the name of the automaker) of the owner of battery 12 is also shown in section M11.

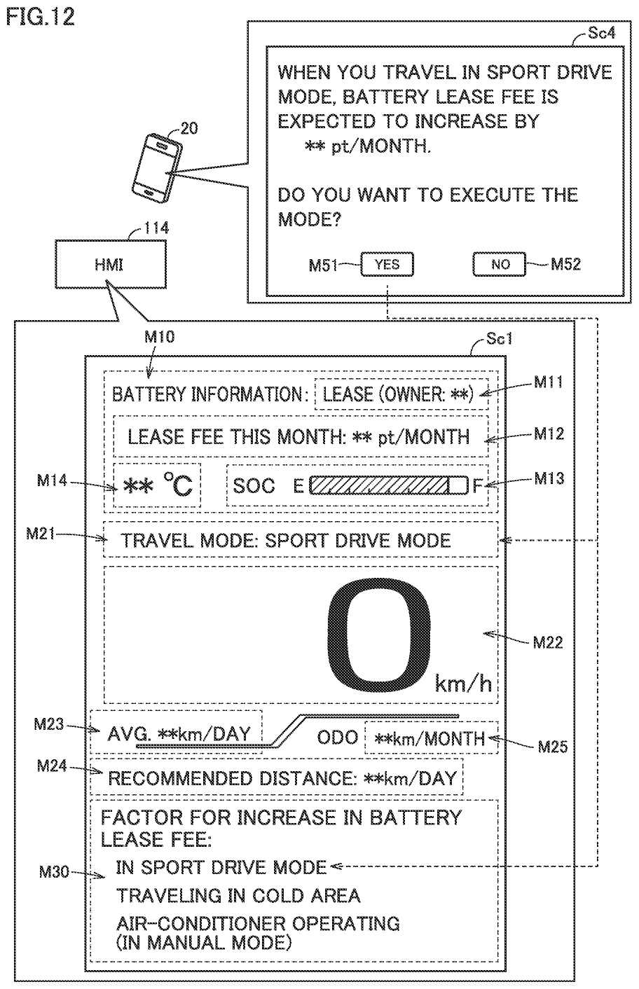

The current drive mode of vehicle 10 is shown in display section M21. A current speed of vehicle 10 is shown in display section M22. An average travel distance of vehicle 10 per day of this month is shown in display section M23. An average travel distance (a recommended distance) per day recommended by management center 500 is shown in display section M24. The recommended distance will be described later (see FIGS. 11 and 12). The cumulative travel distance of vehicle 10 of this month is shown in display section M25. A factor for increase in lease fee of vehicle 10 is shown in display section M30. In the example shown in FIG. 8, there is no factor for increase in lease fee, and hence a message to that effect is shown in display section M30. A state of display section M30 when there is a factor for increase in lease fee will be described later (see FIGS. 11 and 12). In an example where battery 12 is owned by the user (that is, not leased), screen Sc1 from which display sections M24, M30, and M12 are removed may be shown on the meter panel. When management center 500 receives information on vehicle 10 from server 150 through the processing in S110 and S180 in FIG. 5 or in S280 in FIG. 6, it transmits battery information including the form of use and the lease fee to vehicle 10. Management center 500 thus notifies vehicle 10 of the determined lease fee. When vehicle 10 receives the notification, the user terminal (for example, HMI 114) of vehicle 10 shows the determined lease fee. Specifically, the lease fee is shown in section M12 shown in FIG. 8.

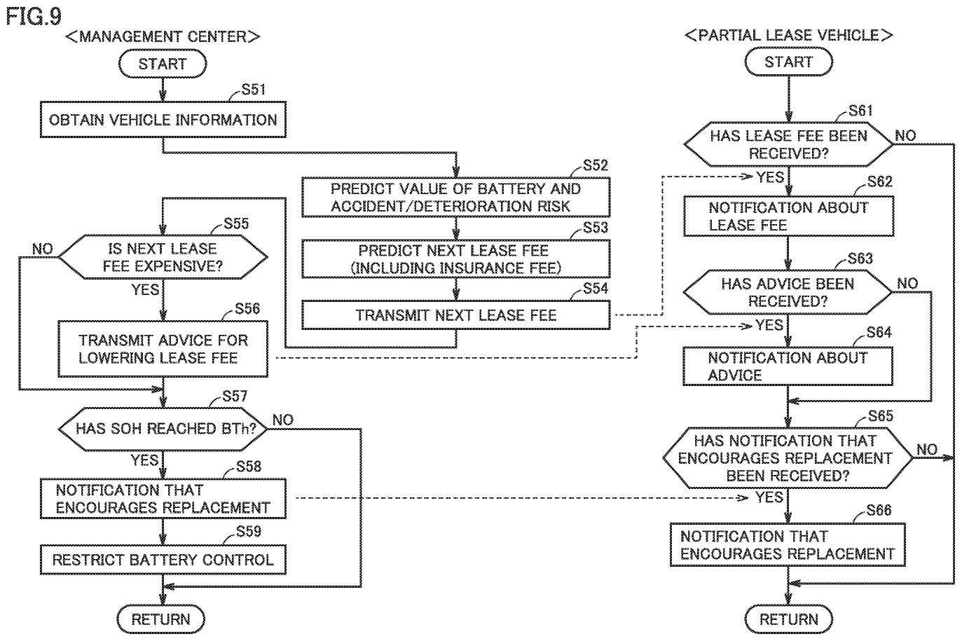

Furthermore, management center 500 repeatedly performs a series of processing from S51 to S59 in FIG. 9 which will be described below, for each vehicle A (partial lease vehicle). In the series of processing shown in FIG. 9, vehicle A to be processed is referred to as a “subject vehicle.” The lease fee of the subject vehicle (partial lease vehicle) corresponds to the battery lease fee.

FIG. 9 is a flowchart showing control for suppression of rise of the lease fee in the method of leasing the power storage according to this embodiment.

Referring to FIG. 9 together with FIGS. 1, 4, and 8, in S51, management center 500 obtains the SOH, the accident factor parameter, and the deterioration factor parameter of the subject vehicle during a period from a time point of start of the assessment period until the current time point (which is referred to as an “intermediate period” below) from the vehicle information (FIG. 4) stored in storage 520. In succession, in S52, assuming that the subject vehicle will be used also during a remaining assessment period (that is, a period from the current time point to a time point of end of the assessment period) as in the intermediate period, management center 500 predicts the value of the battery, the accident risk, and the deterioration risk at the time point of end of the assessment period from the SOH, the accident factor parameter, and the deterioration factor parameter obtained in S51. In S53, management center 500 then uses each map shown in FIG. 7 to predict the lease fee for the next lease period (in this embodiment, the lease fee in the next month) based on the predicted value of the battery, accident risk, and deterioration risk. In succession, in S54, management center 500 transmits the predicted lease fee (that is, the next lease fee) to the subject vehicle.

In succession, in S55, management center 500 determines whether or not the predicted lease fee is equal to or higher than a prescribed reference fee. The prescribed reference fee is, for example, an amount the same as the lease fee for the present lease period (in this embodiment, the lease fee in the present month) or an amount calculated by addition of a prescribed amount thereto. When the predicted lease fee is equal to or higher than the prescribed reference fee (YES in S55), in S56, a signal indicating advice for lowering the lease fee (which is also referred to as an “advice signal” below) is transmitted to the subject vehicle, and thereafter the process proceeds to S57. When the predicted lease fee is lower than the prescribed reference fee (NO in S55), on the other hand, the process proceeds to S57 without the advice signal being transmitted.

In S57, management center 500 determines whether or not the SOH (capacity retention rate) of the battery mounted on the subject vehicle has become equal to or lower than BTh. BTh is determined in S161 in FIG. 5 and updated in S261 in FIG. 6.

When the SOH of the battery is equal to or lower than BTh (YES in S57), in S58, management center 500 gives the subject vehicle a notification (which is referred to as a “replacement notification” below) that encourages replacement of the battery under the insurance service. In succession, in S59, management center 500 transmits a signal indicating restriction of use of the battery mounted on the subject vehicle (which is referred to as a “restriction signal” below) to the subject vehicle. In the subject vehicle that has received the restriction signal, use of the battery is restricted. Progress of deterioration of the battery is thus suppressed. In this embodiment, while the subject vehicle receives the restriction signal, the battery mounted on the subject vehicle is unable to output electric power (kW) exceeding a prescribed value (for example, an upper limit value indicated by the restriction signal).

When the processing in S59 is performed, the process returns to the initial step (S51). While the SOH of the battery is equal to or lower than BTh, processing in S58 and S59 is continued. When the SOH of the battery is higher than BTh (NO in S57), the process returns to the initial step (S51) without processing in S58 and S59 being performed. When the battery is replaced in the subject vehicle, the SOH of the battery becomes higher than BTh. Therefore, the processing in S58 and S59 is no longer performed and restriction of use of the battery (S59) is removed. Thus, when the capacity retention rate of the battery becomes equal to or lower than the prescribed threshold value (BTh), management center 500 restricts control of the battery by the subject vehicle to protect the battery, and when replacement of the battery is completed in the subject vehicle, management center 500 removes restriction on control. The restriction signal (S59) may prohibit charging (quick charging) of the battery in which charging power (kW) exceeds a prescribed value, in addition to or instead of restriction of output described previously.

A series of processing from S61 to S66 is repeatedly performed by ECU 111 (FIG. 8) of the subject vehicle. In S61, the subject vehicle determines whether or not it has received the predicted lease fee (S54). When the subject vehicle has received the predicted lease fee (YES in S61), the process proceeds to S62. In S62, the subject vehicle notifies the user of the predicted lease fee. In following S63, the subject vehicle determines whether or not it has received the advice signal (S56). When the subject vehicle has received the advice signal (YES in S63), in S64, it notifies the user of advice indicated in the advice signal. Thereafter, the process proceeds to S65. When the lease fee predicted by management center 500 is sufficiently low (NO in S55), on the other hand, the subject vehicle does not receive the advice signal (NO in S63). In this case, the process proceeds to S65 without the processing in S64 being performed.

In S65, the subject vehicle determines whether or not it has received a replacement notification (S58). When the subject vehicle has received the replacement notification (YES in S65), in following S66, the subject vehicle encourages the user to replace the battery through prescribed notification processing. Thereafter, the process returns to the initial step (S61). When the SOH of the battery mounted on the subject vehicle is sufficiently high (NO in S57), on the other hand, the subject vehicle does not receive the replacement notification (NO in S65). In this case, the process returns to the initial step (S61) without the processing in S66 being performed.

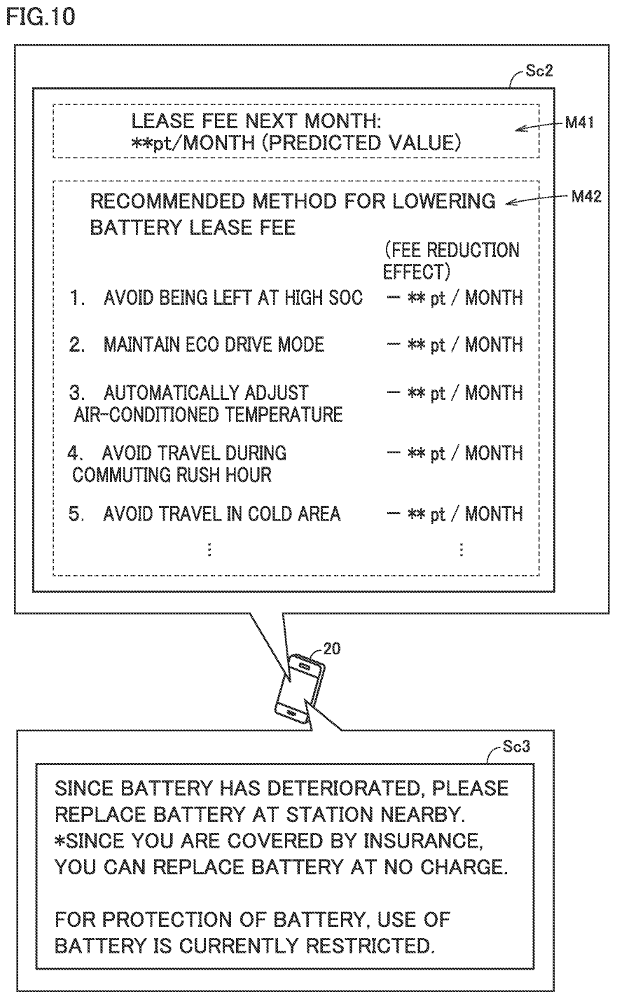

FIG. 10 is a diagram for illustrating notification processing (S62, S64, and S66 in FIG. 9). Referring to FIG. 10, when the subject vehicle receives the next lease fee from management center 500 (S54 in FIG. 9), ECU 111 of the subject vehicle has a screen Sc2 shown on the user terminal (for example, portable terminal 20) of the subject vehicle. In the example shown in FIG. 10, screen Sc2 includes a display section M41 where the next lease fee is shown and a display section M42 where advice indicated in the advice signal is shown. When the subject vehicle does not receive the advice signal, Sc2 not including display section M42 is shown on the user terminal.

In this embodiment, when it is predicted that the next lease fee becomes expensive (YES in S55 in FIG. 9), management center 500 notifies the subject vehicle of a plurality of measures for lowering the lease fee, together with an amount of lowering in lease fee owing to each measure (S56 in FIG. 9). ECU 111 of the subject vehicle then instructs portable terminal 20 to show screen Sc2 in response to the notification from management center 500 (S64 in FIG. 9). Portable terminal 20 shows the measures for lowering the lease fee in accordance with the instruction from the subject vehicle, together with ranking of the amount of lowering in lease fee owing to the measures. More specifically, portable terminal 20 shows the measures in a form of ranking in the descending order of magnitude of an effect of reduction in fee (see display section M42). Each measure may be a measure for reducing a factor for an accident of the subject vehicle or a factor for deterioration of the battery.

When the subject vehicle receives the replacement notification from management center 500 (S58 in FIG. 9), ECU 111 of the subject vehicle has, for example, a screen Sc3 shown on the user terminal (for example, portable terminal 20) of the subject vehicle (S66 in FIG. 9). Screen Sc3 includes a message encouraging the user to replace the battery. Screen Sc3 shown in FIG. 10 notifies the user of restriction of use of the battery. Screen Sc3 further includes explanation of the insurance service relating to battery replacement.

Each vehicle A (partial lease vehicle) registered in management center 500 performs a series of processing shown in FIG. 11 which will be described below, in parallel to the series of processing from S61 to S66 shown in FIG. 9.

FIG. 11 is a flowchart showing notification control carried out by the partial lease vehicle in the method of leasing the power storage according to this embodiment. Processing shown in this flowchart is repeatedly performed by ECU 111 of vehicle A (partial lease vehicle).

Referring to FIG. 11 together with FIGS. 1, 4, and 8, in S71, ECU 111 obtains a recommended distance from management center 500. Management center 500 determines the recommended distance in response to the request from the partial lease vehicle and transmits the recommended distance to the partial lease vehicle. Specifically, management center 500 determines a target distance for lowering the lease fee without convenience of the user being excessively compromised, based on the cumulative travel distance during the intermediate period (S51 in FIG. 9) and the predicted lease fee (S54 in FIG. 9). The target distance corresponds to a target value of the cumulative travel distance at the time point of end of the assessment period. Management center 500 then determines the recommended distance (a recommended value of the average travel distance per day) based on the target distance and transmits the recommended distance. When the partial lease vehicle receives the recommended distance from management center 500, ECU 111 has the recommended distance shown on the user terminal (for example, HMI 114) of the partial lease vehicle, for example, in display section M24 shown in FIG. 8.

In following S72, ECU 111 determines whether or not it has been requested by the user to make switching to the sport drive mode. The user can request ECU 111 to change the drive mode through the input device (HMI 114). When the user requests ECU 111 to switch to the sport drive mode (YES in S72), in S73, ECU 111 obtains an increment in lease fee (which is also referred to as an “increment originating from the drive mode” below) predicted at the time of switching to the sport drive mode from management center 500. Management center 500 predicts the increment originating from the drive mode in response to the request from the partial lease vehicle and transmits the predicted value to the partial lease vehicle. When the partial lease vehicle receives the predicted value, in S74, ECU 111 has the increment (predicted value) originating from the drive mode shown on the user terminal (for example, portable terminal 20) of the partial lease vehicle and requests the user to provide an input indicating whether or not to switch to the sport drive mode. The user can provide the input to ECU 111 through portable terminal 20. When the user provides the input to portable terminal 20 to switch to the sport drive mode, ECU 111 switches to the sport drive mode and thereafter the process proceeds to S75. When the user provides the input to portable terminal 20 not to switch to the sport drive mode, on the other hand, the process proceeds to S75 without switching to the sport drive mode being made.

In S75, ECU 111 determines whether or not the user has requested the operation of air-conditioner 117 in the manual mode. The user can request ECU 111 to have air-conditioner 117 operate or to change the mode of air-conditioner 117 by operating an operation portion of air-conditioner 117. When the user requests ECU 111 to have air-conditioner 117 operate in the manual mode (YES in S75), in S76, ECU 111 obtains from management center 500, a predicted increment in lease fee (which is also referred to as an “increment originating from the air-conditioner” below) at the time when air-conditioner 117 operates in the manual mode. Management center 500 predicts the increment originating from the air-conditioner in response to the request from the partial lease vehicle and transmits the predicted value to the partial lease vehicle. When the partial lease vehicle receives the predicted value, in S77, ECU 111 has the increment (the predicted value) originating from the air-conditioner shown on the user terminal (for example, portable terminal 20) of the partial lease vehicle and requests the user to provide an input indicating whether or not to have air-conditioner 117 operate in the manual mode. The user can provide the input to ECU 111 through portable terminal 20. When the user provides the input to portable terminal 20 to have air-conditioner 117 operate in the manual mode, ECU 111 has air-conditioner 117 operate in the manual mode and thereafter the process proceeds to 578. When the user provides the input to portable terminal 20 not to have air-conditioner 117 operate in the manual mode, on the other hand, the process proceeds to S78 without air-conditioner 117 operating in the manual mode.

In S78, ECU 111 determines whether or not there is a factor for increase in lease fee (lease fee increasing factor) in the partial lease vehicle. ECU 111 of the partial lease vehicle according to this embodiment regards a factor for increase in accident risk of the vehicle (accident risk factor) and a factor for increase in deterioration risk of the battery (deterioration risk factor) as the lease fee increasing factors. The accident risk factor includes at least one (for example, all) of travel in the congested environment, travel in the sport drive mode, and travel in the cold area. The deterioration risk factor includes at least one (for example, all) of the battery being maintained in a state where the SOC is equal to or more than the deterioration threshold value (which is also referred to as “being left at high SOC” below), the operation of the air-conditioner in the manual mode, travel in the congested environment, travel in the sport drive mode, and travel in the cold area.

When there is a lease fee increasing factor in the partial lease vehicle (YES in S78), in S79, ECU 111 has the lease fee increasing factor shown on the user terminal (for example, HMI 114) of the partial lease vehicle. For example, the lease fee increasing factor is shown in display section M30 shown in FIG. 8. Thereafter, the process returns to the initial step (S71). When there is no lease fee increasing factor in the partial lease vehicle (NO in S78), the process returns to the initial step (S71) without processing in S79 being performed.

FIG. 12 is a diagram for illustrating exemplary notification in processing shown in FIG. 11. In the example shown in FIG. 12, in the processing in S71 in FIG. 11, the latest recommended distance is shown in display section M24 in screen Sc1. In the processing in S74 in FIG. 11, for example, a screen Sc4 is shown on portable terminal 20. Screen Sc4 shows the increment (predicted value) originating from the drive mode. Furthermore, a message requesting the user to provide an input indicating whether or not to switch to the sport drive mode is shown on screen Sc4. Screen Sc4 includes an operation portion M51 for accepting an input indicating that switching to the sport drive mode is to be made and an operation portion M52 for accepting an input indicating that switching to the sport drive mode is not to be made.

When the user operates operation portion M52, switching to the sport drive mode is not made. When the user operates operation portion M51, on the other hand, switching to the sport drive mode is made. Furthermore, when switching to the sport drive mode is made, in the processing in S79 in FIG. 11, travel in the sport drive mode is added as the lease fee increasing factor in display section M30 in screen Sc1. In the processing in S79 in FIG. 11, another lease fee increasing factor present in the partial lease vehicle is also shown in display section M30.

As described above, the method of leasing the power storage according to this embodiment includes processing shown in FIGS. 3, 5, 6, 9, and 11. In this embodiment, the processing is performed by execution by at least one processor, of a program stored in at least one memory. The processing, however, may be performed by dedicated hardware (electronic circuitry) rather than software. In this embodiment, server 150 and management center 500 cooperate to function as an exemplary “computer apparatus” according to the present disclosure.

Specifically, in each of S130 in FIG. 5 and S230 in FIG. 6, server 150 obtains, for the vehicle including the power storage, the value of the power storage based on the capacity retention rate of the power storage. In each of S161 and S171 in FIG. 5 and S261 and S271 in FIG. 6, server 150 determines the insurance fee for the user of the vehicle to receive the insurance service relating to replacement of the power storage based on the accident risk of the vehicle. In each of S162 and S172 in FIG. 5 and S262 and S272 in FIG. 6, server 150 determines the lease fee of the power storage based on the value of the power storage and the insurance fee.

In the leasing method, obtaining of the value of the power storage based on the capacity retention rate of the power storage facilitates proper assessment of the value of the power storage. Furthermore, in the leasing method, not only the fee paid by the user for the power storage (that is, the fee in accordance with the value of the power storage) but also the insurance fee paid by the user for reception of the insurance service is included in the lease fee of the power storage. In the leasing method, the insurance fee is determined based on the accident risk of the vehicle. In the event that the vehicle is involved in an accident, possibility of replacement of the power storage mounted on that vehicle is high. Therefore, determination of the insurance fee based on the accident risk facilitates proper assessment of the insurance fee. Thus, according to the leasing method described above, in the lease service not only simply for rental of the power storage for the vehicle but also for rental of the power storage with the value being added, the lease fee of the power storage can properly be determined.

In the method of leasing the power storage according to this embodiment, when the body portion except for the power storage of the vehicle is the property of the user and the power storage is provided to the user by lease (YES in S150 in FIG. 5 or S250 in FIG. 6), in S161 in FIG. 5 or S261 in FIG. 6, server 150 determines the insurance fee in first insurance fee determination processing. The first insurance fee determination processing is processing for determining the insurance fee based on the accident risk of the vehicle and the deterioration risk of the power storage. When both of the body portion and the power storage are provided to the user by lease (NO in S150 in FIG. 5 or S250 in FIG. 6), on the other hand, in S171 in FIG. 5 or S271 in FIG. 6, server 150 determines the insurance fee in second insurance fee determination processing. The second insurance fee determination processing is processing for determining the insurance fee based only on the accident risk, of the accident risk and the deterioration risk.

In the partial lease vehicle, the accident of the vehicle and deterioration of the power storage are main causes of replacement of the power storage. Therefore, determination of the insurance fee based on both of the accident risk and the deterioration risk as above facilitates appropriate determination of the insurance fee. For the full lease vehicle, the accident of the vehicle is the main cause of replacement of the power storage. Therefore, determination of the insurance fee based on the accident risk without the deterioration risk being taken into account facilitates appropriate determination of the insurance fee. Thus, according to the method described above, appropriate determination of the insurance fee for each of the partial lease vehicle and the full lease vehicle is facilitated.

In each of S261 and S271 in FIG. 6, server 150 assesses the accident risk based on travel data (for example, the comprehensive travel frequency, the congestion travel frequency, the sport travel frequency, and the cold area travel frequency) of the vehicle during the assessment period preceding the coverage period of the insurance service, and determines the insurance fee for the coverage period based on the accident risk assessed in connection with the assessment period (see FIG. 7). In S261 in FIG. 6, server 150 determines the insurance fee for the coverage period based on the accident risk and the deterioration risk assessed in connection with the assessment period. Server 150 assesses the accident risk based on the comprehensive travel frequency. Specifically, server 150 assesses the accident risk as being higher as the travel distance or the time period of travel of the vehicle during the assessment period is longer. Server 150 assesses the deterioration risk based on the high SOC time period and the cold area travel frequency. Specifically, server 150 assesses the deterioration risk as being higher as the time period during which the remaining amount of stored power of the power storage is equal to or larger than a prescribed value is longer during the assessment period. Server 150 assesses the deterioration risk as being higher as the distance or the time period of travel of the vehicle in the cold area is longer during the assessment period.

In the leasing method, use of the travel data of the vehicle during the assessment period preceding the coverage period of the insurance service facilitates proper assessment of the accident risk. The deterioration risk is assessed as being higher as the time period during which the remaining amount of stored power of the power storage is equal to or larger than the prescribed value is longer during the assessment period, which facilitates proper assessment of the deterioration risk. The deterioration risk is assessed as being higher as the distance or the time period of travel of the vehicle in the cold area is longer during the assessment period, which again facilitates proper assessment of the deterioration risk. According to such a method, appropriate determination of the insurance fee based on at least one of the assessed accident risk and the assessed deterioration risk is facilitated.

Processing flows shown in FIGS. 3, 5, 6, 9, and 11 can be modified as appropriate. For example, depending on an object, the order of processing may be changed or an unnecessary step may be omitted. Contents in any processing may be modified. For example, management center 500 can give each notification shown in FIG. 9 to a user terminal outside the vehicle, in addition to or instead of the user terminal mounted on the vehicle.

In the embodiment, a length (unit period) of the lease period is set to one month. Without being limited as such, the unit period can freely be set, and a period longer than one month (for example, three months, six months, or one year) may be set. The assessment period can also be changed as appropriate. For example, the entire period covered by the insurance in the past may be defined as the assessment period and then the lease fee (including the insurance fee) for the next lease period (for example, a next month) may be determined. The replacement requirement (S21 in FIG. 3) can also be modified as appropriate, without being limited to the requirement described above. The exclusion requirement can also freely be set without being limited to the requirement described above.

Contents shown on screens Sc1 to Sc4 can also be modified as appropriate. For example, an average time period of travel (recommended time period) per day recommended by management center 500 instead of the recommended distance may be shown in display section M24 in screen Sc1. The user terminal on which each screen is shown can also be changed as appropriate. For example, screen Sc1 may be shown on a head-up display instead of the meter panel.

Server 150 or management center 500 alone may function as the “computer apparatus” according to the present disclosure. For example, server 150 may perform the function of management center 500. Alternatively, management center 500 may perform the function of server 150. In the embodiment, the processing shown in FIGS. 5 and 6 is performed by server 150 (dealer terminal). Without being limited as such, management center 500 instead of server 150 may be configured to perform the processing shown in FIGS. 5 and 6. Alternatively, server 250 may be configured to function as the “computer apparatus” according to the present disclosure.

In this embodiment, management center 500, server 150, and server 250 are each an on-premise server. Without being limited as such, the function of each server may be implemented on the cloud by cloud computing. In other words, these servers may be cloud servers. A location where the lease service is provided is not limited to dealer 100. For example, management center 500 may provide the lease service on-line (for example, on the cloud).

The vehicle for which the battery is leased may be an xEV (electrically powered vehicle) other than the BEV. The vehicle may include an internal combustion engine (for example, a gasoline engine, a biofuel engine, or a hydrogen engine). The vehicle is not limited to a four-wheel passenger car, but may be a bus or a truck, or a three-wheel xEV. The vehicle may be provided with a solar panel. The vehicle may be configured to wirelessly be chargeable. The vehicle may be configured to be able to autonomous drive or may perform a flying function. The vehicle may be a vehicle (for example, a robo-taxi, an automated guided vehicle (AGV), or an agricultural machine) that can travel without human intervention.

Though an embodiment of the present disclosure has been described, it should be understood that the embodiment disclosed herein is illustrative and non-restrictive in every respect. The scope of the present disclosure is defined by the terms of the claims and is intended to include any modifications within the scope and meaning equivalent to the terms of the claims.

What is claimed is:

1. A method of leasing a power storage comprising:
obtaining, for a vehicle including a power storage, a value of the power storage based on a capacity retention rate of the power storage;
determining an insurance fee for a user of the vehicle to receive an insurance service relating to replacement of the power storage based on an accident risk of the vehicle; and
determining a lease fee of the power storage based on the value of the power storage and the insurance fee.

2. The method of leasing a power storage according to claim 1, wherein
the determining an insurance fee includes
assessing the accident risk based on travel data of the vehicle during an assessment period preceding a coverage period of the insurance service, and
determining the insurance fee for the coverage period based on the accident risk assessed in connection with the assessment period, and
the travel data includes at least one of (i) a cumulative travel distance or a cumulative time period of travel of the vehicle and (ii) a distance or a time period of travel of the vehicle in a congested environment.

3. The method of leasing a power storage according to claim 1, wherein
the determining an insurance fee includes
first insurance fee determination processing for determining the insurance fee based on the accident risk of the vehicle and a deterioration risk of the power storage, and
second insurance fee determination processing for determining the insurance fee based only on the accident risk, of the accident risk and the deterioration risk, and
the method further comprises:
determining the insurance fee in the first insurance fee determination processing when a body portion except for the power storage of the vehicle is a property of the user and the power storage is provided to the user by lease; and
determining the insurance fee in the second insurance fee determination processing when both of the body portion and the power storage are provided to the user by lease.

4. The method of leasing a power storage according to claim 3, wherein
the determining the insurance fee in the first insurance fee determination processing includes
assessing the accident risk as being higher as a distance or a time period of travel of the vehicle is longer during an assessment period preceding a coverage period of the insurance service,
assessing the deterioration risk as being higher as a time period during which a remaining amount of stored power of the power storage is equal to or larger than a prescribed value is longer during the assessment period, and
determining the insurance fee for the coverage period based on the accident risk and the deterioration risk assessed in connection with the assessment period.

5. The method of leasing a power storage according to claim 4, wherein
the determining the insurance fee in the first insurance fee determination processing further includes assessing the deterioration risk as being higher as the distance or the time period of travel of the vehicle in a cold area is longer during the assessment period.

6. A computer apparatus comprising:
a processor; and
a storage where a program causing the processor to perform the method of leasing a power storage according to claim 1 is stored.

7. A lease system for lease of a power storage, the lease system comprising:
the computer apparatus according to claim 6; and
a user terminal of the vehicle, wherein
the computer apparatus is configured to notify the user terminal of the determined lease fee, and
the user terminal is configured to show the lease fee.

8. The lease system for lease of a power storage according to claim 7, wherein
the computer apparatus is configured to notify the user terminal of measures for lowering the lease fee, together with an amount of lowering in the lease fee owing to the measures, and
the user terminal is configured to show the measures for lowering the lease fee, together with ranking of the amount of lowering in the lease fee owing to the measures.

9. The lease system for lease of a power storage according to claim 7, wherein
the computer apparatus gives to the user terminal, a notification that encourages replacement of the power storage under the insurance service when the capacity retention rate of the power storage becomes equal to or less than a prescribed threshold value.

10. The lease system for lease of a power storage according to claim 9, wherein
when the capacity retention rate of the power storage becomes equal to or less than the prescribed threshold value, the computer apparatus restricts control of the power storage by the vehicle to protect the power storage, and when replacement of the power storage is completed in the vehicle, the computer apparatus removes restriction on the control.
